(19) United States
(12) Patent Application Publication
(10) Pub. No.: US 2014/0225847 A1
(43) Pub. Date: Aug. 14, 2014

(54) TOUCH PANEL APPARATUS AND INFORMATION PROCESSING METHOD USING SAME

(71) Applicants: Kazunori Sakayori, Kashiwa-shi (JP); Akihiro Okano, Tokyo (JP)

(72) Inventors: Kazunori Sakayori, Kashiwa-shi (JP); Akihiro Okano, Tokyo (JP)

(73) Assignees: PIONEER SOLUTIONS CORPORATION, Kawasaki-shi (JP); PIONEER CORPORATION, Kawasaki-shi (JP)

(21) Appl. No.: 14/240,872

(22) PCT Filed: Aug. 25, 2011
(86) PCT No.: PCT/JP2011/069155

§ 371 Date: Apr. 16, 2014

(51) Int. Cl. G06F 3/0484; G06F 3/0488; G06F 3/041

(52) U.S. Cl. CPC G06F 3/04845; G06F 3/0416; G06F 3/0488
USPC 345/173

(57) ABSTRACT

A touch panel device includes: an image-displaying section configured to display a plurality of object images on the display surface; a specifying section configured to specify one of the object images that has a display area with which the pointer including two or more pointers contacts or almost contacts; a motion-detecting section configured to detect a motion of the two or more pointers; a first display-changing section configured to change a display state of the object image specified by the specifying section when it is determined that the motion of the two or more pointers is a predetermined motion; and a second display-changing section configured to change a display state of rest of the object images when the first display-changing section changes the display state of the specified object image.

### TECHNICAL FIELD

The present invention relates to a touch panel device and an information processing method using the same.

### BACKGROUND ART

There has been conventionally known a touch panel device that performs processing in accordance with a contact or almost-contact position in a display surface of the touch panel device. Such a touch panel device is capable of switching an image on the display surface to perform various types of processing and thus is used in a variety of applications. In the touch panel device, the orientation, position and size of an object image can be changed in accordance with the contact state of a finger on the display surface.

Various ways are considered to improve the operability of the above touch panel device (see, for instance, Patent Literature 1).

Patent Literature 1 discloses that when a button is touched with a plurality of fingers, a variety of processing is performed in accordance with a distance between the fingers or a transient change in the distance.

### CITATION LIST

### Patent Literature(S)

Patent Literature 1: JP-A-2001-228971

### SUMMARY OF THE INVENTION

### Problem(S) to be Solved by the Invention

The above arrangement of Patent Literature 1, however, requires displaying an operation button in addition to an object image, so that the processing of the touch panel device may become complicated.

Further, the object image and the operation button may be displayed at a distance so that the object image can be easily distinguished from the operation button. In such a case, the object image to be operated may be less distinguishable from another object image that is not to be operated.

Further, in order to eliminate such a disadvantage that the object image is less distinguishable, a button may be displayed at a specific position on the object image. In such a case, however, for instance, when the object image is turned, the position of the button on the display surface is inevitably changed along with each turn of the object image. Accordingly, a touch position needs to be changed after each turn of the object image, so that operability may be deteriorated.

An object of the invention is to provide: a touch panel device that has a simple arrangement for easily changing the display state of an object image displayed on a display surface and allows the object image to be easily distinguished from another object image that is not to be operated; and an information processing method using the touch panel device.

### Means for Solving the Problem(s)

According to an aspect of the invention, a touch panel device that performs a process in accordance with a position of a pointer that contacts or almost contacts with a display surface of the touch panel device, the touch panel device includes: an image-displaying section configured to display a plurality of object images on the display surface; a specifying section configured to specify one of the object images that has a display area with which the pointer including two or more pointers contacts or almost contacts; a motion-detecting section configured to detect a motion of the two or more pointers; a first display-changing section configured to change a display state of the object image specified by the specifying section when it is determined that the motion of the two or more pointers is a predetermined motion; and a second display-changing section configured to change a display state of rest of the object images when the first display-changing section changes the display state of the specified object image.

According to another aspect of the invention, an information processing method using a touch panel device that performs a process in accordance with a position of a pointer that contacts or almost contacts with a display surface of the touch panel device, the method includes: displaying a plurality of object images on the display surface; specifying one of the object images that has a display area with which the pointer including two or more pointers contacts or almost contacts; detecting a motion of the two or more pointers that contact or almost contact with the display area of the specified object image; primarily changing a display state of the specified object image when it is determined that the motion of the two or more pointers is a predetermined motion; and secondarily changing a display state of rest of the object images in response to the primarily changing.

### BRIEF DESCRIPTION OF DRAWING(S)

FIG. 1 is a perspective view showing a touch panel device according to first to seventh exemplary embodiments of the invention.

FIG. 2 schematically shows an arrangement of an infrared emitting/receiving unit of the touch panel device.

FIG. 3 is a block diagram schematically showing an arrangement of the touch panel device.

FIG. 4 schematically shows a display state before a display-changing process according to the first to seventh exemplary embodiments.

FIG. 5 is a flow chart showing the display-changing process according to the first exemplary embodiment.

FIG. 6 schematically shows a display state at the time when an operation other than double-tapping is done according to the first exemplary embodiment.

FIG. 7 schematically shows a display state at the time when another operation other than double-tapping is done according to the first exemplary embodiment.

FIG. 8 schematically shows a display state at the time when double-tapping is done according to the first exemplary embodiment.

FIG. 9 schematically shows a display state at the time when double-tapping is done in the state shown in FIG. 8 according to the first exemplary embodiment.

FIG. 10 schematically shows a display state at the time when double-tapping is done according to the second exemplary embodiment.

FIG. 11 schematically shows a display state at the time when double-tapping is done according to the third exemplary embodiment.

FIG. 12 schematically shows a display state at the time when double-tapping is done according to the fourth exemplary embodiment.

FIG. 13 schematically shows a display state at the time when double-tapping is done according to the fifth exemplary embodiment.

FIG. 14 schematically shows a display state at the time when double-tapping is done according to the sixth exemplary embodiment.

FIG. 15 schematically shows a display state at the time when double-tapping is done according to the seventh exemplary embodiment.

### DESCRIPTION OF EMBODIMENT(S)

### First Exemplary Embodiment

The first exemplary embodiment of the invention will be first described with reference to the attached drawings.

### Arrangement of Touch Panel Device

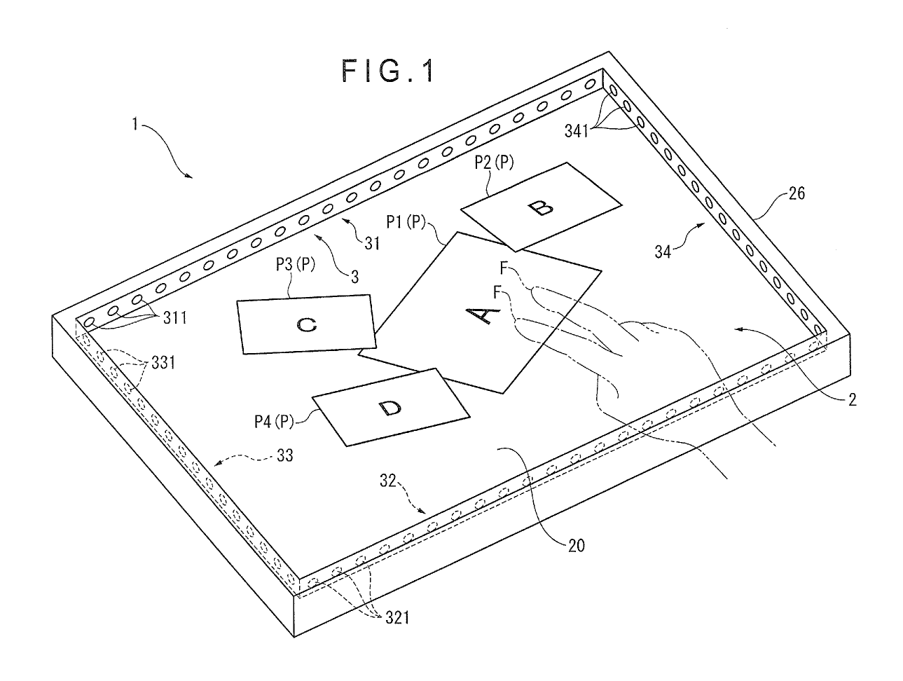

As shown in FIG. 1, a touch panel device 1 is formed in the shape of a table and a display surface 20 is located at the upside thereof. When a finger or fingers F of a person (i.e., a pointer) are in contact or almost in contact with the display surface 20 (a state where the finger or fingers F are in contact or almost in contact with display surface 20 is hereinafter occasionally expressed as “existing on/above the display surface 20”), the touch panel device 1 performs processing in accordance with the contact or almost-contact position (the contact or almost-contact position is hereinafter occasionally expressed as “existing position”).

As shown in FIGS. 1 to 3, the touch panel device 1 includes a display 2, an infrared emitting/receiving unit 3 and controller 4.

The display 2 includes the display surface 20 in a rectangular shape (i.e., a touch-panel surface). The display 2 is received in a rectangular frame 26.

The infrared emitting/receiving unit 3 includes: a first emitter 31 provided on one of a pair of first side portions (i.e., long sides) of the frame 26; a first light-receiver 32 provided on the other of the first side portions; a second emitter 33 provided on one of a pair of second side portions (i.e., short sides) of the frame 26; and a second light-receiver 34 provided on the other of the second side portions.

The first emitter 31 and the second emitter 33 include a plurality of first emitting elements 311 and a plurality of second emitting elements 331, respectively. The first emitting elements 311 and the second emitting elements 331 are provided by infrared LEDs (Light-Emitting Diodes) capable of emitting an infrared ray L.

The first light-receiver 32 and the second light-receiver 34 include as many first light-receiving elements 321 and the second light-receiving elements 341 as the first emitting elements 311 and the second emitting elements 331, respectively. The first light-receiving elements 321 and the second light-receiving elements 341 are provided by infrared-receiving elements capable of receiving the infrared ray L and are located on the optical axes of the first emitting elements 311 and the second emitting elements 331, respectively.

The first emitting elements 311 and the second emitting elements 331 emit the infrared ray L in parallel with the display surface 20 under the control of the controller 4. Upon reception of the infrared ray L, the first light-receiving elements 321 and the second light-receiving elements 341 each output a light-receiving signal corresponding to the amount of the received infrared ray L to the controller 4.

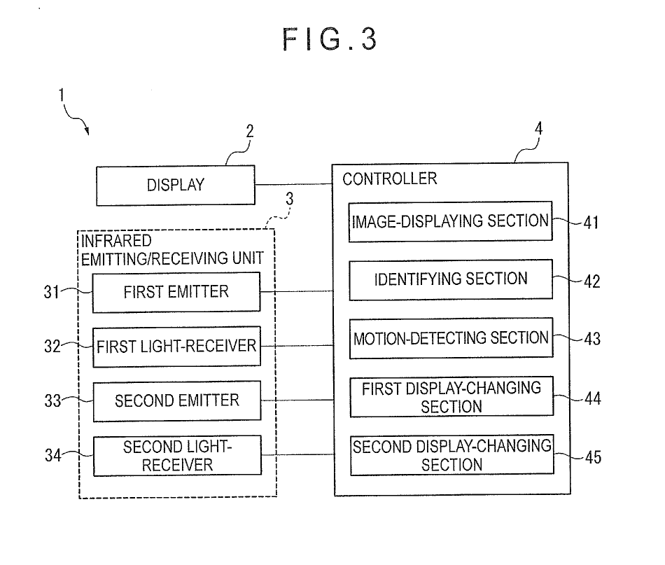

As shown in FIG. 3, the controller 4 includes an image-displaying section 41, a specifying section 42, a motion-detecting section 43, a first display-changing section 44 and a second display-changing section 45, which are provided by processing program and data stored in a storage (not shown) with a CPU (Central Processing Unit).

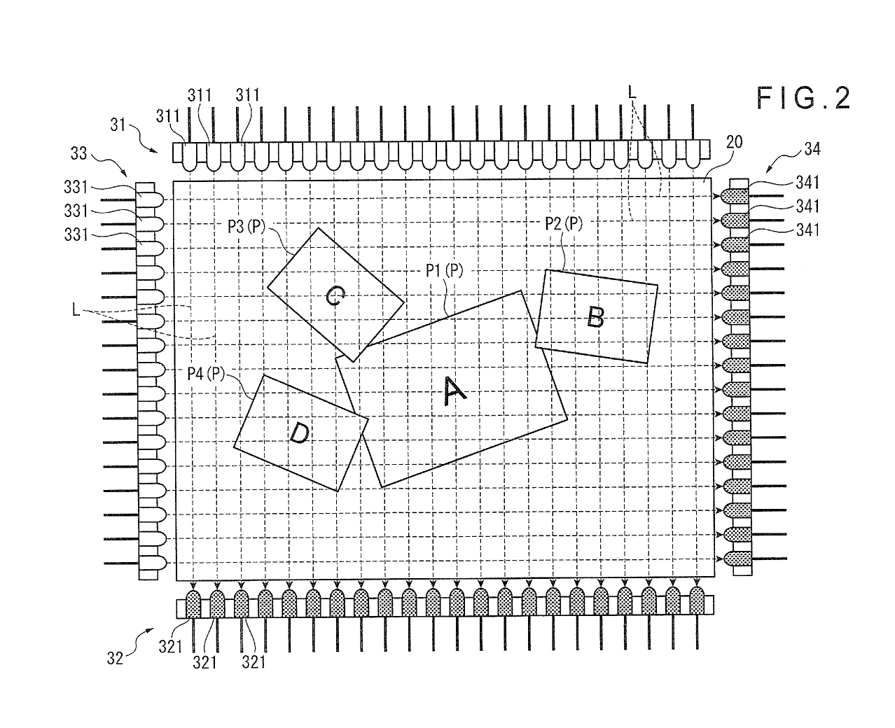

The image-displaying section 41 displays various images on the display surface 20 of the display 2. For instance, as shown in FIGS. 1 and 2, object images P1, P2, P3 and P4 are displayed. Incidentally, the object images P1 to P4 are also collectively referred to as object images P as long as it is not particularly necessary to separately describe them.

In the exemplary embodiment, examples of the object images P are: documents, tables and graphs made by various types of software; images of landscapes and people captured by imaging devices; and image contents such as animation and movies.

The specifying section 42 performs scanning on the display surface 20 with the infrared ray L from the first emitting elements 311 and the second emitting elements 331, and determines the existence of the finger or fingers F on/above the display surface 20 upon detection of interception of the infrared ray L. The specifying section 42 also detects the number of the finger or fingers F based on the number of the light-intercepted position(s).

Further, the specifying section 42 specifies, from among the object images P displayed on the display surface 20, one displayed in an area overlapping with the existing area of the finger or fingers F. In other words, the specifying section 42 specifies one of the object images P that is displayed in an area contacted or almost contacted with the finger or fingers F.

When the specifying section 42 determines the existence of the finger or fingers F on/above the display surface 20, the motion-detecting section 43 detects the motion of the finger or fingers F. Specifically, the motion-detecting section 43 detects a change of a light-intercepted position as the motion of the finger or fingers F. When two or more of the fingers F exist on/above the display surface 20, the motion-detecting section 43 detects the motion of each of the fingers F.

The first display-changing section 44 changes the display state of the object image P specified by the specifying section 42 depending on the number and/or the motion of the finger or fingers F detected by the motion-detecting section 43.

In response to the process by the first display-changing section 44, the second display-changing section 45 changes the display states of the object images P other than the object image P whose display state is changed by the first display-changing section 44.

### Operation of Touch Panel Device

Next, the operation of the touch panel device 1 will be explained. It should be noted that a case where the display surface 20 is contacted (touched) with the finger or fingers F is exemplarily described herein to explain the operation, but the touch panel device 1 operates in the same manner even when the display surface 20 is almost contacted with the finger or fingers F.

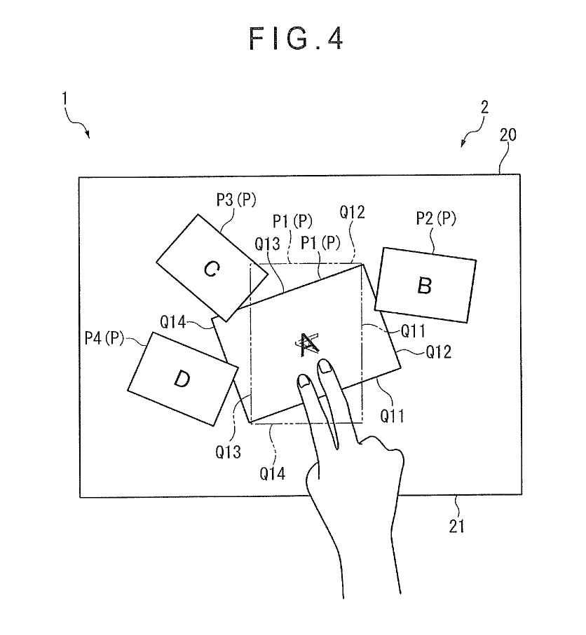

Upon detection that, for instance, the device is switched on and a predetermined operation is performed, the image-displaying section 41 of the controller 4 of the touch panel device 1 displays the object images P on the display surface 20 as shown in FIG. 4 (step S1).

When a user of the touch panel device 1 wishes to move one of the object images P or change the size or orientation of one of the object images P, he/she touches the object image P (i.e., the display area of the object image P in the display surface 20) with the finger or fingers F and moves the finger or fingers F.

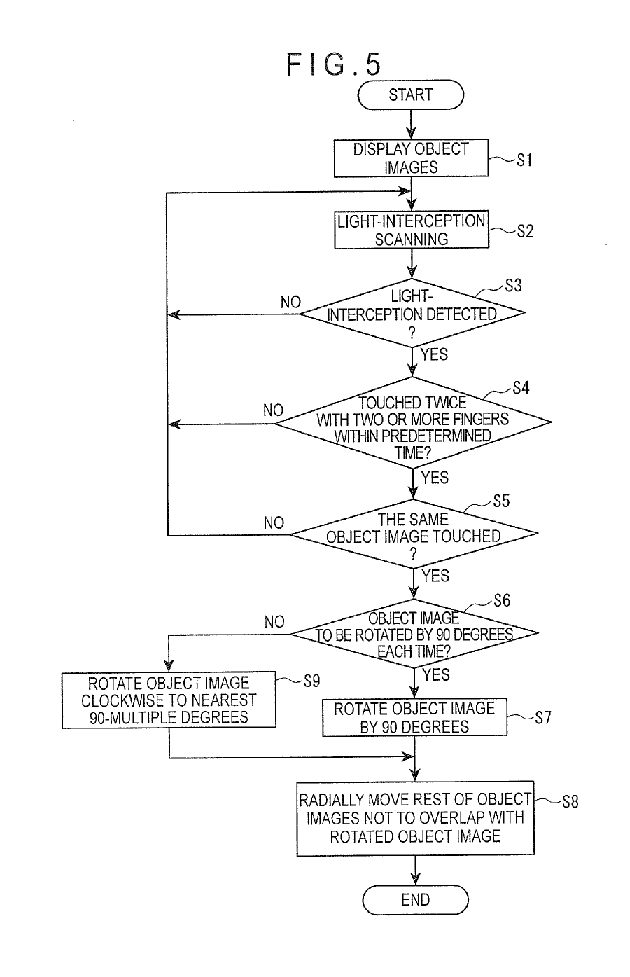

Subsequently, the specifying section 42 performs a light-interception scanning with the infrared ray L to determine whether or not the finger or fingers F are in touch with the display surface 20 as shown in FIG. 5 (step S2). The specifying section 42 then determines whether or not interception of the infrared ray L is detected (step S3). The processes in step S2 and step S3 are repeated until interception of the infrared ray L is detected.

Specifically, during repetition of step S2 and step S3, the specifying section 42 activates the first emitting elements 311 one by one to emit the infrared ray L in a sequential manner from the leftmost one in FIG. 2. Similarly, the specifying section 42 activates the second emitting elements 331 one by one to emit the infrared ray L in a sequentially manner from the uppermost one in FIG. 2. The specifying section 42 then determines whether or not light interception is detected based on light-receiving signals from the first light-receiving elements 321 and the second light-receiving elements 341 that are correspondingly opposed to the first emitting elements 311 and the second emitting elements 331.

When light interception is detected in step S3, the specifying section 42 and the motion-detecting section 43 determine whether or not the display surface 20 is touched twice with two or more of the fingers F within a predetermined duration of time (e.g., one second) (step S4). In other words, it is determined whether or not the display surface 20 is intermittently touched twice with the fingers F within the predetermined duration of time. Incidentally, it may be determined whether or not the display surface 20 is intermittently touched three or more times with the fingers F.

When the specifying section 42 and the motion-detecting section 43 determine that the display surface 20 is not intermittently touched twice with the fingers F within the predetermined duration of time in step S4, the process returns to step S2 after a predetermined process is performed as needed.

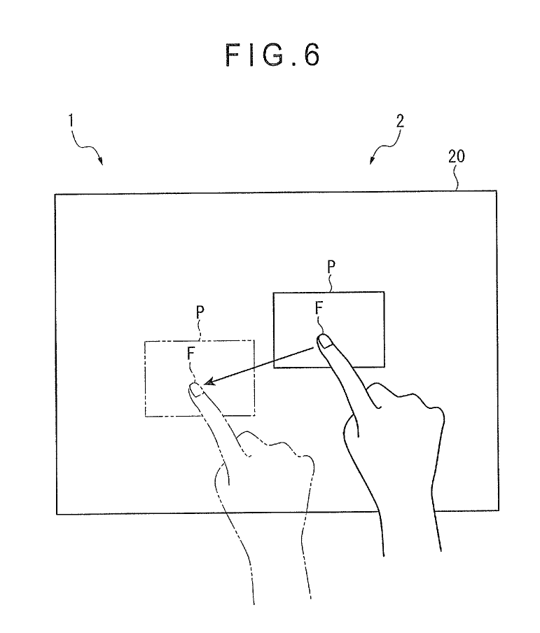

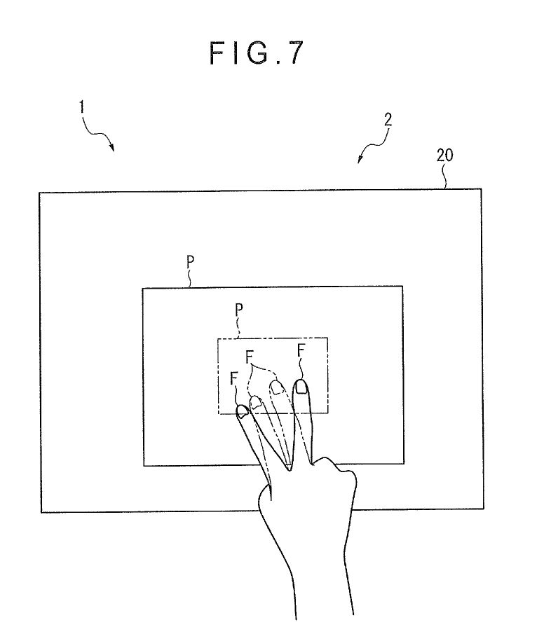

For instance, when one of the object images P is touched with one of the fingers F and then finger F is slid without being away from the display surface 20 as shown in FIG. 6, the process returns to step S2 after the object image P is moved along with the sliding motion of the finger F. Further, when one of the object images P is touched with two of the fingers F and then fingers F are slid to be distanced from each other without being away from the display surface 20 as shown in FIG. 7, the process returns to step S2 after the object image P is enlarged as the two fingers F are distanced from each other.

When the specifying section 42 and the motion-detecting section 43 determine that the display surface 20 is intermittently touched twice (double-touched) with the fingers F within the predetermined duration of time in step S4, it is determined whether or not the same object image P is touched (step S5). Specifically, while the specifying section 42 of the controller 4 specifies the object image P1 that is touched with the two fingers F, the motion-detecting section 43 of the controller 4 detects the motions of the two fingers F with which the object image P1 is touched, thereby determining whether or not the same object image P is intermittently touched with the two fingers F. When it is determined that the same object image P is not touched with the two fingers F (e.g., while one of the fingers F is in touch with the object image P, the other finger F is in touch with a portion different from this object image P) in step S5, the process returns to step S2.

When the specifying section 42 and the motion-detecting section 43 determine that the same object image P is touched with the two fingers F in step S5, the first display-changing section 44 determines whether or not this object image P is an object image intended to be rotated by 90 degrees each time (step S6).

Specifically, when any one of first long side Q11, first short side Q12, second long side Q13 and second short side Q14 of the object image P1 in a rectangular shape is parallel with a first long side 21 of the display surface 20 in a rectangular shape as shown by a chain double-dashed line in FIG. 4, the first display-changing section 44 determines that the object image P1 is an object image intended to be rotated by 90 degrees each time (i.e., an object image intended to be rotated clockwise by 90 degrees).

When none of the sides Q11 to Q14 is parallel with the first long side 21 as shown by a solid line in FIG. 4, the first display-changing section 44 determines that the object image P1 is not an object image intended to be rotated by 90 degrees each time but an object image that needs to be rotated clockwise only by an angle less than 90 degrees (rotated clockwise to the nearest 90-multiple degrees) so that any one of the sides Q11 to Q14 becomes parallel with the first long side 21.

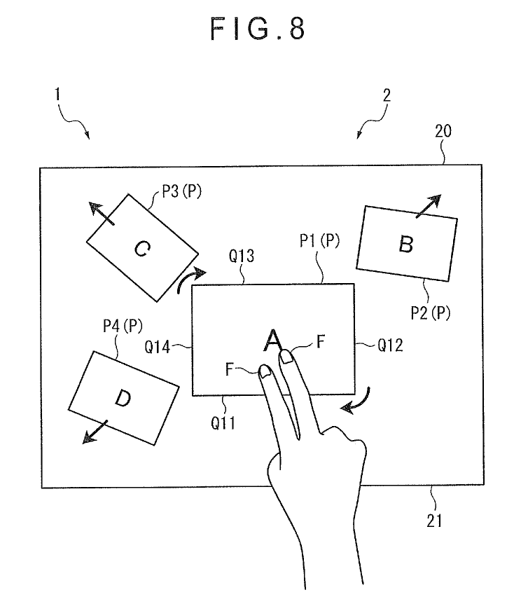

When determining that the object image P1 is an object image intended to be rotated by 90 degrees each time as shown by the chain double-dashed line in FIG. 4 in step S6, the first display-changing section 44 rotates the object image P1 clockwise (counterclockwise in FIG. 8) by 90 degrees to bring the first long side Q11 of the object image P1 to be opposite to and parallel with the first long side 21 as shown in FIG. 8 (step S7). Subsequently, the second display-changing section 45 radially moves the object image P2, the object image P3 and the object image P4, which are not to be rotated by the first display-changing section 44, so as not to overlap with the rotated object image P1 (step S8), and then the process is completed. Incidentally, when at least one of the object image P2, the object image P3 and the object image P4 before being moved does not overlap with the rotated object image P1, such a non-overlapping object image may not be moved or may be moved in the same manner as the overlapping images in step S8.

When determining that the object image P1 is not an object image intended to be rotated by 90 degrees each time as shown by the solid line in FIG. 4 in step S6, the first display-changing section 44 rotates the object image P1 clockwise to the nearest 90-multiple degrees (step S9), thereby bringing the first long side Q11 of the displayed object image P1 to be opposite to and parallel with the first long side 21 as shown in FIG. 8. Subsequently, the second display-changing section 45 performs the process in step S8.

As described above, when the specifying section 42 and the motion-detecting section 43 determine that the object image P1 is intermittently touched twice with the two fingers F, the first display-changing section 44 changes the display area of the object image P1 by rotating the object image P1 in order to change the display state of the object image P1. In the above process, the first display-changing section 44 rotates the object image P1 until the orientation of the object image P1 at the time when the display surface 20 is viewed from the first long side 21 (i.e., a predetermined position) becomes a preset orientation with any one of the sides Q11 to Q14 being parallel with the first long side 21. Further, in response to the process of the first display-changing section 44, the second display-changing section 45 changes the display states of the object images P2 to P4 (i.e., the object images other than the object image P1) by changing the display areas of the object images P2 to P4. Specifically, the second display-changing section 45 moves the object images P2 to P4 to avoid overlap of the display areas of the object images P2 to P4 with that of the object image P1.

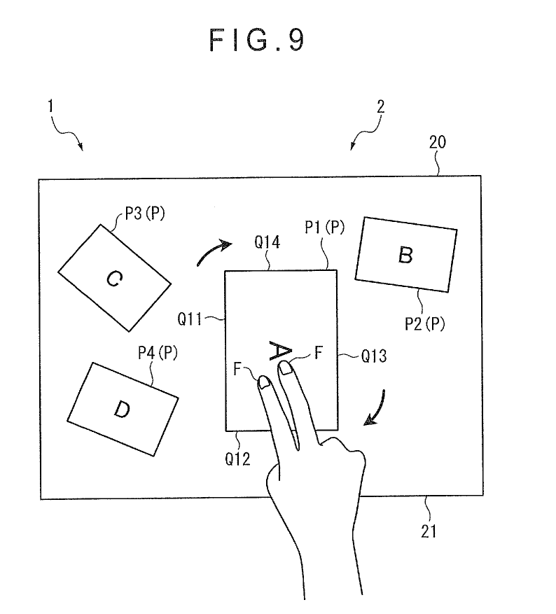

Incidentally, when the process in step S5 is again performed in the state shown in FIG. 8, the controller 4 sequentially performs the processes in step S6, step S7 and step S8, thereby rotating the object image P1 clockwise by 90 degrees to bring the first short side Q12 of the object image P1 to be opposite to and parallel with the first long side 21 as shown in FIG. 9.

### Effect(s) of First Exemplary Embodiment

The above first exemplary embodiment provides the following effects (1) to (8).

(1) In the touch panel device 1, when the specifying section 42 and the motion-detecting section 43 detect a predetermined motion of the two fingers F existing on/above the object image P1, the first display-changing section 44 rotates the object image P1 to change the display state of the object image P1. Further, in the touch panel device 1, the second display-changing section 45, in response to the process of the first display-changing section 44, changes the display states of the object images P2 to P4 by moving the object images P2 to P4 not to overlap with the object image P1.

With this arrangement, even when a button for instructing the first display-changing section 44 to perform the process is not displayed on the touch panel device 1, the object image P1 can be rotated. Further, since no button is displayed on the touch panel device 1, even after the rotation of the object image P1, a user can further rotate the object image P1 by touching the same position on the object image P1. Additionally, the touch panel device 1 also changes the display states of the object images P2 to P4 in response to a change in the display state of the object image P1, a user can easily distinguish the object image P1 from the object images P2 to P4.

(2) The second display-changing section 45 changes the display areas of the object images P2 to P4 not to overlap with that of the object image P1. With this arrangement, a user can easily distinguish the object images P2 to P4 as compared with a case where the object images P2 to P4 overlap with the object image P1.

(3) The second display-changing section 45 moves the object images P2 to P4 to change the display areas of the object images P2 to P4. With such a simple arrangement, the second display-changing section 45 allows a user to distinguish the object images P2 to P4 without changing the sizes of the object images P2 to P4.

(4) The first display-changing section 44 changes the display area of the object image P1. With this arrangement, a user can change the display area of the object image P1 by such a simple action as double-tapping and can easily distinguish the object images P2 to P4.

(5) The first display-changing section 44 rotates the object image P1 to change the display area of the object image P1. With this arrangement, a user can change the orientation of the object image P1 as desired by a simple action.

(6) The first display-changing section 44 rotates the object image P1 until the orientation of the object image P1 viewed from the first long side 21 becomes the preset orientation. With this arrangement, a user does not need to finely adjust the orientation of the object image P1 by double-tapping, which results in improved convenience.

### Second Exemplary Embodiment

Next, a second exemplary embodiment of the invention will be described. The second exemplary embodiment and third to sixth exemplary embodiments (described later) are different from the first exemplary embodiment in the process performed by the second display-changing section 45 in step S8.

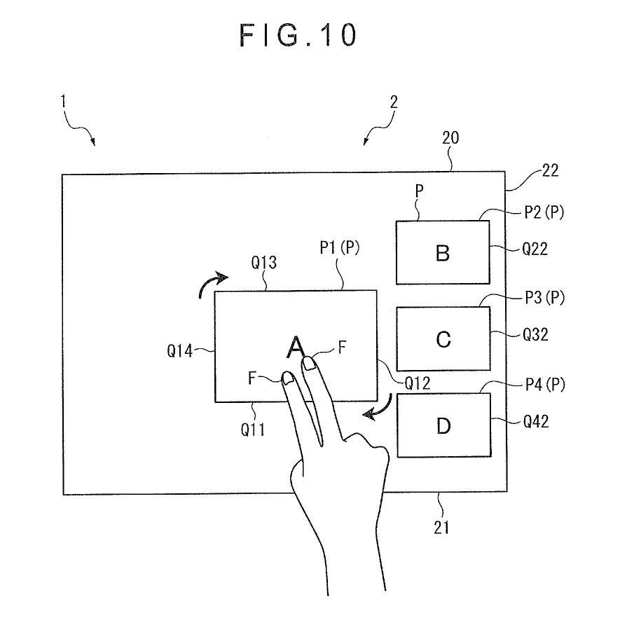

Specifically, after the object image P1 in the state shown in FIG. 4 is rotated through the process in step S7 or step S9, the second display-changing section 45 arranges the object images P2 to P4 along the first short side 22 of the display surface 20 in step S8 as shown in FIG. 10, thereby avoiding overlap of the display areas of the object images P2 to P4 with that of the object image P1. At this time, while being moved, the object images P2 to P4 are rotated to bring a first short side Q22 of the object image P2, a first short side Q32 of the object image P3 and a first short side Q42 of the object image P4 to be opposite to and parallel with the first short side 22.

Incidentally, the object images P2 to P4 may be arranged along the first short side 22 without being rotated.

### Effect(s) of Second Exemplary Embodiment

The above second exemplary embodiment provides the following effects (7) and (8) in addition to the same effects as those of the first exemplary embodiment.

(7) The second display-changing section 45 arranges the object images P2 to P4 along the first short side 22 of the display surface 20. With this arrangement, since the object images P2 to P4 are arranged into a clearly different state as compared with the state before double-tapping, a user can easily distinguish the object images P2 to P4.

(8) The second display-changing section 45 rotates the object images P2 to P4 until the orientations of the object images P2 to P4 become the same as that of the object image P1. With this arrangement, a user can not only easily distinguish the object image P1 from the object images P2 to P4, but also easily understand the contents of the object images P1 to P4.

### Third Exemplary Embodiment

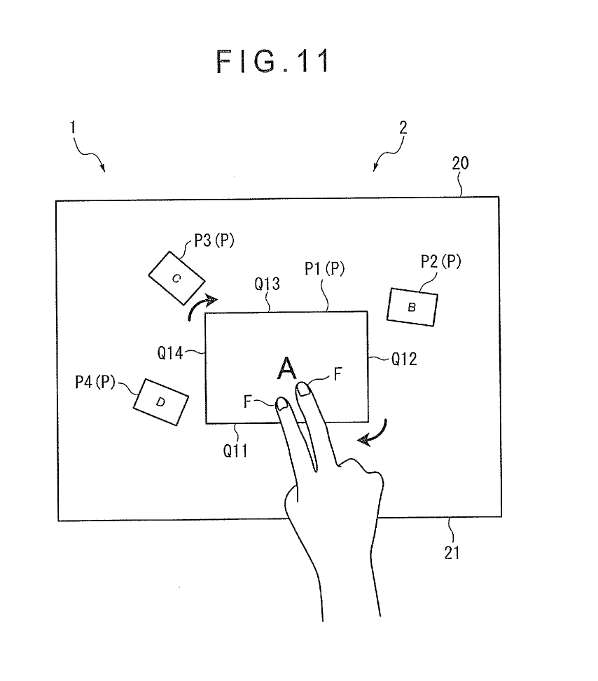

Next, a third exemplary embodiment of the invention will be described. After the object image P1 in the state shown in FIG. 4 is rotated through the process in step S7 or step S9, the second display-changing section 45 downsizes the object images P2 to P4, instead of moving the object images P2 to P4, in step S8 as shown in FIG. 11, thereby avoiding overlap of the display areas of the object images P2 to P4 with that of the object image P1.

### Effect(s) of Third Exemplary Embodiment

The above third exemplary embodiment provides the following effect (9) in addition to the same effects as those of the first and second exemplary embodiments.

(9) The second display-changing section 45 downsizes the object images P2 to P4. With this arrangement, since the sizes of the object images P2 to P4 are changed, a user can easily distinguish these object images.

### Fourth Exemplary Embodiment

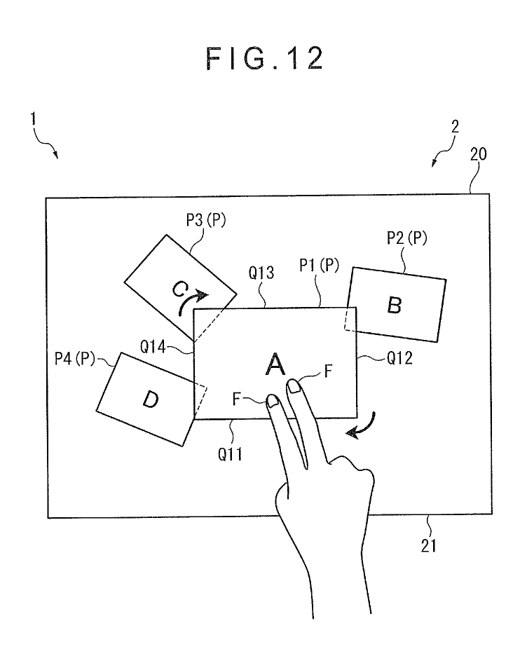

Next, a fourth exemplary embodiment of the invention will be described. After the object image P1 in the state shown in FIG. 4 is rotated through the process in step S7 or S9, the second display-changing section 45 hides portions of the display areas of the object images P2 to P4 that overlap with that of the object image P1 (portions shown by dotted lines in FIG. 12), instead of moving or downsizing the object images P2 to P4, in step S8 as shown in FIG. 12. In other words, the second display-changing section 45 changes the transmittance of each of the object images P2 to P4.

### Effect(s) of Fourth Exemplary Embodiment

The above fourth exemplary embodiment provides the following effect (10) in addition to the same effects as those of the first to third exemplary embodiments.

(10) The second display-changing section 45 hides the portions of the display areas of the object images P2 to P4 that overlap with that of the object image P1. The second display-changing section 45 thus allows a user to distinguish the object images P2 to P4 in such a simple manner as changing the transmittance of a part of each of the object images P2 to P4 without changing the sizes or the positions of the object images P2 to P4.

### Fifth Exemplary Embodiment

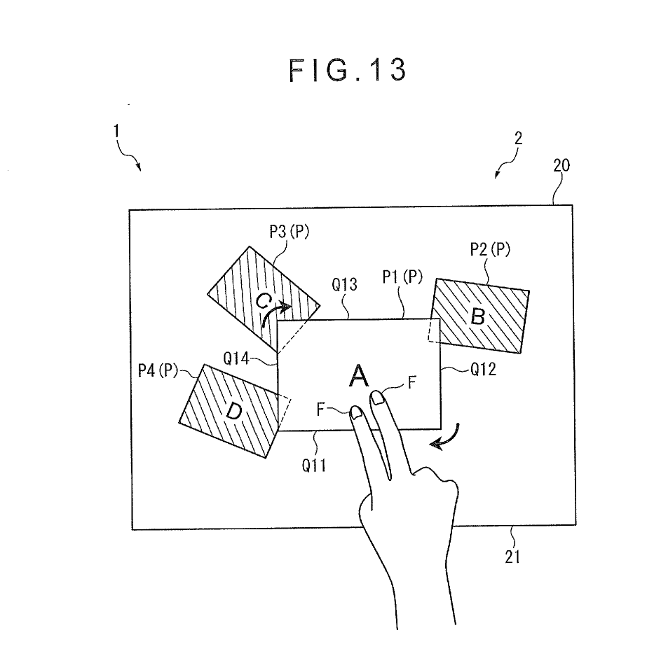

Next, a fifth exemplary embodiment of the invention will be described. After the object image P1 in the state shown in FIG. 4 is rotated through the process in step S7 or S9, the second display-changing section 45 changes at least one of the brightness and saturation of each of the object images P2 to P4 as a whole, instead of moving or downsizing the object images P2 to P4, in step S8 as shown in FIG. 13. Incidentally, the brightness or the saturation of each of the object images P2 to P4 may be partly changed. Alternatively, the object images P2 to P4 may be turned into black-and-white images.

### Effect(s) of Fifth Exemplary Embodiment

The above fifth exemplary embodiment provides the following effect (11) in addition to the same effects as those of the first to fourth exemplary embodiments.

(11) The second display-changing section 45 changes at least one of the brightness and the saturation of each of the object images P2 to P4. With this arrangement, the second display-changing section 45 allows a user to distinguish the object images P2 to P4 in such a simple manner as changing the brightness and/or the saturation of each of the object images P2 to P4 without changing the sizes or the positions of the object images P2 to P4.

### Sixth Exemplary Embodiment

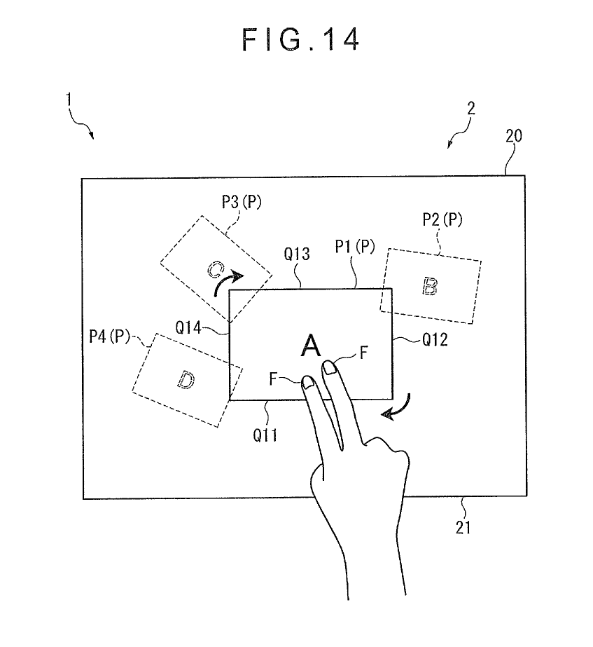

Next, a sixth exemplary embodiment of the invention will be described. After the object image P1 in the state shown in FIG. 4 is rotated through the process in step S7 or S9, the second display-changing section 45 hides the object images P2 to P4, instead of moving or downsizing the object images P2 to P4, in step S8 as shown in FIG. 14.

### Effect(s) of Sixth Exemplary Embodiment

The above sixth exemplary embodiment provides the following effect (12) in addition to the same effects as those of the first to fifth exemplary embodiments.

(12) The second display-changing section 45 hides the object images P2 to P4. With this arrangement, the second display-changing section 45 allows a user to distinguish the object images P2 to P4 in such a simple manner as merely hiding the object images P2 to P4 without changing the sizes or the positions of the object images P2 to P4.

### Seventh Exemplary Embodiment

Next, a seventh exemplary embodiment of the invention will be described. The seventh exemplary embodiment is different from the first exemplary embodiment in the process performed by the first display-changing section 44 in step S7 or S9.

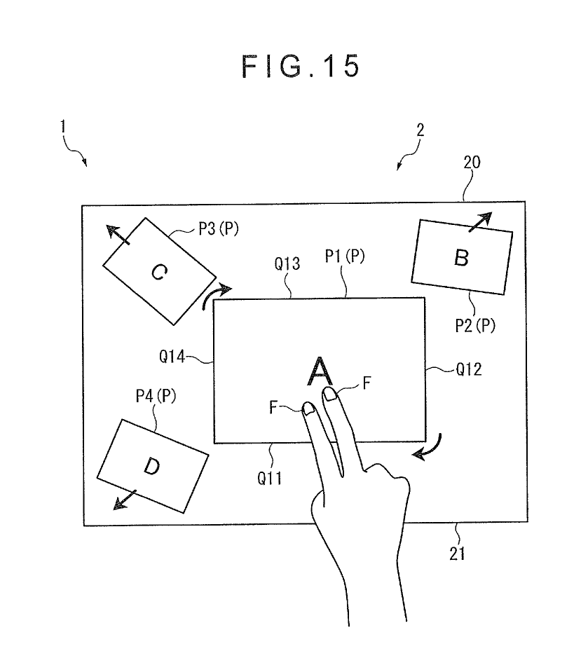

Specifically, before rotating the object image P1 in the state shown in FIG. 4 in step S7 or S9, the first display-changing section 44 enlarges the object image P1 as shown in FIG. 15. Subsequently, the second display-changing section 45 radially moves the object images P2 to P4 not to overlap with the object image P1 in step S8. Incidentally, the second display-changing section 45 may alternatively perform the process according to any one of the second to sixth exemplary embodiments.

### Effect(s) of Seventh Exemplary Embodiment

The above seventh exemplary embodiment provides the following effect (13) in addition to the same effects as those of the first to sixth exemplary embodiments.

(13) The first display-changing section 44 enlarges the object image P1 to change the display area of the object image P1. With this arrangement, a user can easily understand the content of the object image P1.

### Modification(s)

It should be appreciated that the scope of the invention is not limited to the above first to seventh exemplary embodiments but modifications, improvements and the like that are compatible with an object of the invention are included within the scope of the invention.

For instance, although the motion-detecting section 43 detects such a motion of the fingers F that the same object image P is intermittently touched twice with two of the fingers F (i.e., so-called double-tapping), the motion-detecting section 43 may detect that the object image P is touched three or four times or more, or may detect the motion of three or four of the fingers F. Alternatively, the motion-detecting section 43 may detect such a motion that the same object image P is continuously touched for a predetermined duration of time or longer with two or more of the fingers F (i.e., the same object image P is kept touched).

The first display-changing section 44 may downsize or blink one of the object images P instead of rotating or enlarging. Further, the second display-changing section 45 may blink the object images P.

Still further, the second display-changing section 44 may perform an appropriate combination of the processes according to first to sixth exemplary embodiments.

The existing position may be detected by using electrostatic capacity, electromagnetic induction or the like. Alternatively, a data communication via Bluetooth may be used.

A dedicated pen may be used as a pointer in place of the fingers F.

When, for instance, one hand is used as a pointer to operate the device, a combination of the index finger and the middle finger or a combination of the thumb and the index finger may be used. When the thumb and the middle finger are used to operate, the middle finger may contact with the thumb.

When both hands are used to operate, the fingers may be used in various combinations such as a combination of the right index finger and the left index finger and a combination of the right index finger and the left thumb.

The touch panel device 1 may be used as a display for a portable or fixed computer, PDA(Personal Digital Assistant), mobile phone, camera, clock or content player, or may be wall-mountable. Further, the touch panel device 1 may be used to display information for business use or in-car information, or may be used to operate an electronic device.

### EXPLANATION OF CODE(S)

1 . . . touch panel device
20 . . . display surface
41 . . . image-displaying section
42 . . . specifying section
43 . . . motion-detecting section
44 . . . first display-changing section
45 . . . second display-changing section
P . . . object image

1. A touch panel device that performs a process in accordance with a position of a pointer that contacts or almost contacts with a display surface of the touch panel device, the touch panel device comprising:
an image-displaying section configured to display a plurality of object images on the display surface;
a specifying section configured to specify one of the object images that has a display area with which the pointer comprising two or more pointers contacts or almost contacts;
a motion-detecting section configured to detect a motion of the two or more pointers;
a first display-changing section configured to change a display state of the object image specified by the specifying section when it is determined that the motion of the two or more pointers is a predetermined motion; and
a second display-changing section configured to change a display area of rest of the object images not to overlap with the display area of the specified object image when the first display-changing section changes the display state of the specified object image, the second display-changing section downsizing the rest of the object images.

2. (canceled)

3. The touch panel device according to claim 1, wherein the second display-changing section is configured to move the rest of the object images.

4-9. (canceled)

10. The touch panel device according to claim 1, wherein
the first display-changing section is configured to change the display area of the specified object image.

11. The touch panel device according to claim 10, wherein
the first display-changing section is configured to rotate the specified object image by a predetermined angle.

12. The touch panel device according to claim 11, wherein
the first display-changing section is configured to rotate the specified object image until an orientation of the specified object image at a time when the display surface is viewed from a predetermined position becomes a preset orientation.

13. The touch panel device according to claim 10, wherein
the first display-changing section is configured to enlarge the specified object image.

14. The touch panel device according to claim 1, wherein
the first display-changing section is configured to rotate the specified object image until an orientation of the specified object image at a time when the display surface is viewed from a predetermined position becomes a preset orientation, and
the second display-changing section is configured to rotate the rest of the object images until an orientation of the rest of the object images at the time when the display surface is viewed from the predetermined position becomes the same as the orientation of the rotated specified object image.

15. The touch panel device according to claim 1, wherein
the predetermined motion is such a motion that the two or more pointers intermittently contact or almost contact with the display area of the specified object image for a plurality of times within a predetermined duration of time.

16. The touch panel device according to claim 1, wherein
the predetermined motion is such a motion that the two or more pointers continuously contact or almost contact with the display area of the specified object image for a predetermined duration of time or longer.

17. An information processing method using a touch panel device that performs a process in accordance with a position of a pointer that contacts or almost contacts with a display surface of the touch panel device, the method comprising:
displaying a plurality of object images on the display surface;
specifying one of the object images that has a display area with which the pointer comprising two or more pointers contacts or almost contacts;
detecting a motion of the two or more pointers that contact or almost contact with the display area of the specified object image;
primarily changing a display state of the specified object image when it is determined that the motion of the two or more pointers is a predetermined motion; and
secondarily changing a display area of rest of the object images not to overlap with the display area of the specified object image in response to the primarily changing, the secondarily changing comprising downsizing the rest of the object images.

18. (canceled)

19. The information processing method using the touch panel device according to claim 17, wherein
the secondarily changing comprises moving the rest of the object images.

20-25. (canceled)

26. The information processing method using the touch panel device according to claim 17, wherein
the primarily changing comprises changing the display area of the specified object image.

27. The information processing method using the touch panel device according to claim 26, wherein
the primarily changing comprises rotating the specified object image by a predetermined angle.

28. The information processing method using the touch panel device according to claim 27, wherein
the primarily changing comprises rotating the specified object image until an orientation of the specified object image at a time when the display surface is viewed from a predetermined position becomes a preset orientation.

29. The information processing method using the touch panel device according to claim 26, wherein
the primarily changing comprises enlarging the specified object image.

30. The information processing method using the touch panel device according to claim 17, wherein
the primarily changing comprises rotating the specified object image until an orientation of the specified object image at a time when the display surface is viewed from a predetermined position becomes a preset orientation, and
the secondarily changing comprises rotating the rest of the object images until an orientation of the rest of the object images at the time when the display surface is viewed from the predetermined position becomes the same as the orientation of the rotated specified object image.

31. The information processing method using the touch panel device according to claim 17, wherein
the predetermined motion is such a motion that the two or more pointers intermittently contact or almost contact with the display area of the specified object image for a plurality of times within a predetermined duration of time.

32. The information processing method using the touch panel device according to claim 17, wherein
the predetermined motion is such a motion that the two or more pointers continuously contact or almost contact with the display area of the specified object image for a predetermined duration of time or longer.
